(19) United States
(12) Patent Application Publication
(10) Pub. No.: US 2026/0080264 A1
(43) Pub. Date: Mar. 19, 2026

(54) FEDERATED LEARNING WITH NEURAL GRAPH REVEALERS

(71) Applicant: Microsoft Technology Licensing, LLC, Redmond, WA (US)

(72) Inventors: Urszula Stefania CHAJEWSKA, Camano Island, WA (US); Harsh SHRIVASTAVA, Redmond, WA (US)

(21) Appl. No.: 18/889,342

(22) Filed: Sep. 18, 2024

(51) Int. Cl. G06N 3/098; G06N 3/042

(52) U.S. Cl. CPC G06N 3/098; G06N 3/042

(57) ABSTRACT

Methods and apparatuses are described for providing a federated learning platform that utilizes Neural Graph Revealers, which are a type of Probabilistic Graphical Model (PGM). The federated learning platform generates and stores Neural Graph Revealers using sparse graph recovery techniques by aggregating client models that were trained using private datasets. Each client may generate a locally trained NGR model that is trained using data that is private to that client, and then the locally trained NGR models for each client may be aggregated to generate a global NGR model. The federated learning platform may maintain a global NGR model that learns the averaged information from the local trained NGR models associated with each client while the training data for each client is kept secure within the client's environment.

### BACKGROUND

Recent years have seen rapid growth in the capability and sophistication of artificial intelligence (AI) and machine learning (ML) software applications. For instance, deep neural networks have seen widespread adoption due to their diverse processing capabilities in vision, speech, language, and decision making. Commensurate with their capabilities, deep neural networks are complex, oftentimes comprising millions if not billions of individual parameters. Accordingly, various organizations deploy large-scale computing infrastructure, such as cloud computing, to offer AI platforms tailored to enabling users to make use of cutting-edge neural networks.

### BRIEF SUMMARY

Systems and methods for enabling a federated learning platform to generate personalized client-specific models for a large number of clients without experiencing model parameter explosion as the number of clients increases are provided. The federated learning platform may utilize Neural Graph Revealers (NGRs) and generate a global NGR using client-specific models without requiring private datasets from clients. Each client may generate a locally trained NGR model that is trained using data that is private to that client, and then the locally trained NGR models for each client may be aggregated to generate the global NGR model. The federated learning platform may maintain a global NGR model that learns the averaged information from the local trained NGR models associated with each client. For clients that have local variables that are not part of the combined global distribution of the global NGR model, a stitching procedure that personalizes the global NGR model on a per client basis is performed. The stitching procedure includes merging additional variables with the global NGR model based on each client's dataset to improve each client's local NGR model. The privacy of each client's data is maintained throughout the stitching procedure.

According to some embodiments, the technical benefits of the systems and methods disclosed herein include increased model accuracy and predictive power, increased NGR model performance while the number of parameters in the global NGR model remains comparable to the number of client models, reduced cost of computing and storage resources for developing NGR models, and reduced power consumption of computing and storage resources for developing NGR models. Other technical benefits can also be realized through various implementations of the disclosed technologies.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Like-numbered elements may refer to common components in the different FIGURES.

FIG. 1A depicts one embodiment of a networked computing environment for providing a federated learning platform that utilizes NGRs.

FIG. 1B depicts one embodiment of a fully connected neural network.

FIG. 1C depicts one embodiment of neural graph revealer (NGR).

FIG. 1D depicts one embodiment in which additional nodes have been added to a personalized NGR.

FIG. 2A depicts one embodiment of a computing environment in which the disclosed technology may be practiced.

FIG. 2B depicts one embodiment of various components of the computing system in FIG. 2A.

FIG. 3A depicts a flowchart describing one embodiment of a process for generating an NGR model.

FIG. 3B depicts a flowchart describing another embodiment of a process for generating an NGR model.

### DETAILED DESCRIPTION

The technologies described herein provide a federated learning platform for generating models that utilizes Neural Graph Revealers (NGRs). In some cases, the federated learning platform generates and stores Probabilistic Graphical Models (PGMs) using sparse graph recovery techniques by aggregating client models that were trained using private datasets. Allowing clients to share locally trained client models without sharing their private datasets ensures data privacy that is critical in many domains with privacy concerns, such as healthcare. Each client generates a locally trained NGR model that is trained using data that is private to that client, and then the locally trained NGR models for each client are aggregated to generate a global NGR model. The federated learning platform maintains a global NGR model that learns the averaged information from the local trained NGR models associated with each client while the training data for each client is kept secure within the client's environment.

In some embodiments, when a global NGR model only covers the common feature set across all clients (e.g., only covers the intersection of features across all clients) and some clients have local variables that are not part of the combined global distribution of the global NGR model, then a stitching procedure that personalizes the global NGR model on a per client basis is performed. The stitching procedure merges additional variables with the global NGR model based on each client's dataset to extend each client's local NGR model. In one example, the stitching procedure includes updating a local NGR model by adding nodes for client-specific features to the input and output layers of the local NGR model, adding additional hidden nodes to each hidden layer of the local NGR model, connecting all new input nodes to the first hidden layer nodes of the local NGR model, and connecting all nodes in the last hidden layer to the new nodes in the output layer of the local NGR model. The weights of the updated local NGR model are then initialized and the updated local NGR model is retrained using the client's dataset that includes the additional variables.

The technical benefits of the federated learning platform that utilizes a global NGR model include no growth or limited growth in the size of the global NGR model as the number of clients or the diversity of clients increases, thereby eliminating model parameter explosion as the number of clients increases and allowing the federated learning platform to generate personalized models for a large number of clients. Technical benefits of utilizing a stitching procedure for improving local NGR models include increased local NGR model performance while the number of parameters in the global NGR model remains comparable to the number of client models and while maintaining data privacy.

In some embodiments, federated learning is used to generate models based on proprietary data from multiple clients in such a way that the multiple clients retain control over the privacy of their data, while all clients benefit from improved model accuracy due to pooled resources. There are two primary network architectures used for federated learning: the centralized paradigm and the decentralized paradigm. The centralized paradigm is where one global model is maintained, and the local models are updated periodically. Centralized federated learning frameworks utilize a federated matched averaging algorithm (or its variants) which performs neuron matching to tackle the permutation invariance in the neural network-based architectures. Dummy neurons are introduced while optimizing using the Hungarian matching algorithm, causing the global model size to blow up considerably (e.g., the number of model parameters increases significantly as clients are added to the centralized federated learning framework). In addition, current federated learning frameworks are usually developed with keeping specific deep learning architectures in mind. For instance, it is not straightforward to handle skip connections in current federated learning systems due to the dynamic resizing of neural network layers. The decentralized paradigm performs decoupled learning in a peer-to-peer communication system. The federated learning platform described herein works with both the centralized paradigm and the decentralized paradigm.

An NGR is a type of PGM that utilizes a deep neural network to learn complex non-linear dependencies between input features. In general, PGMs offer greater flexibility than predictive models, as they learn a distribution over all features in a domain and can answer queries about any variable's probability conditional on an assignment of values to any other feature or set of features. NGRs may learn the underlying distribution from multimodal data (e.g., from both text and image data). NGRs differ from other PGMs by integrating both structure learning and parameter learning thus eliminating the need for external structure learning methods which introduce unwarranted assumptions. NGRs learn to capture the underlying data distribution and have efficient algorithms for inference and sampling. One technical benefit of using NGRs is that they do not require a dependency structure as input to the training algorithm. Instead, NGRs recover the structure and learn the network parameterization at the same time with a loss function that jointly optimizes dependency structure sparsity and fit to the data. In some cases, the dependency structure identifies which features in the local data (e.g., client-specific data) are directly dependent on each other and which pairs of features in the local data exhibit conditional independencies given other features.

In some cases, a neural network (e.g., an NGR) comprises a computer algorithm or model (e.g., a classification model, regression model, language model, etc.) that is tuned or trained based on training input to approximate unknown functions or values. A neural network may comprise a fully connected neural network or a fully connected multi-layer perceptron having an architecture that learns or approximates functions that indicate connections between features of input data. In some cases, an NGR is configured to learn a sparse graphical model and fit a regression with nodes in both the input and output of the neural graph revealer representing the features of the given input data.

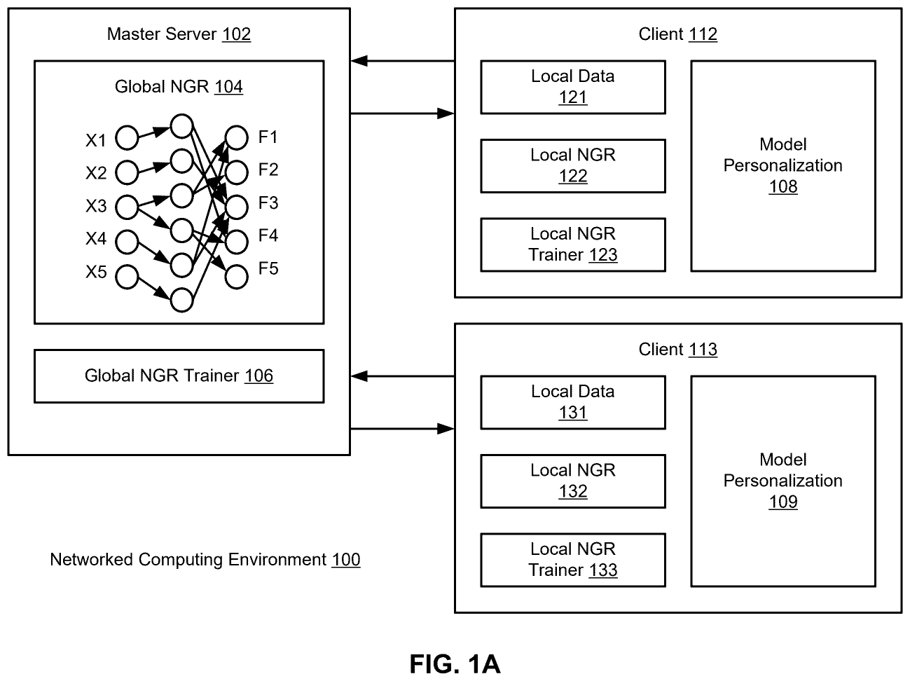

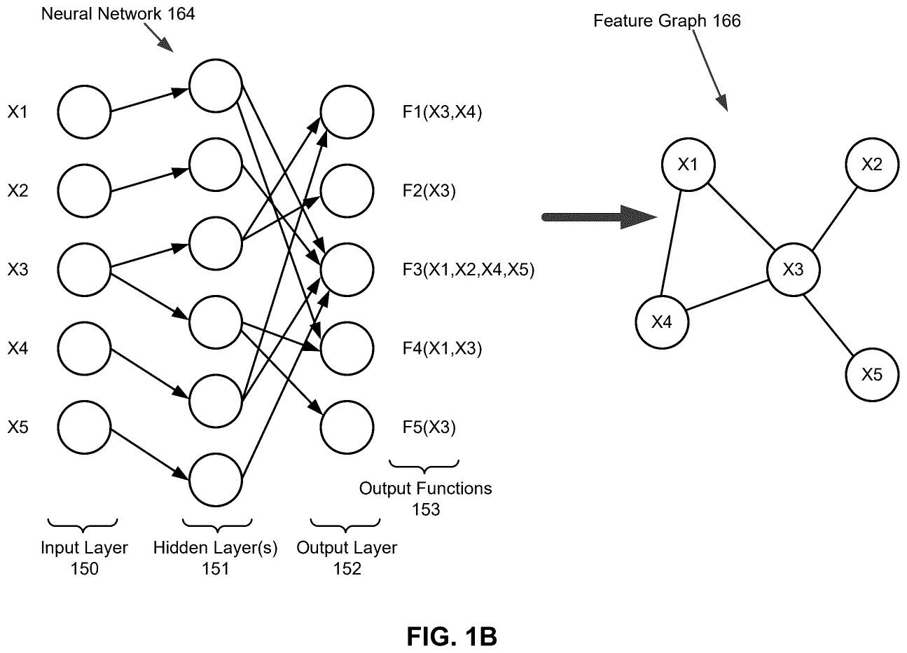

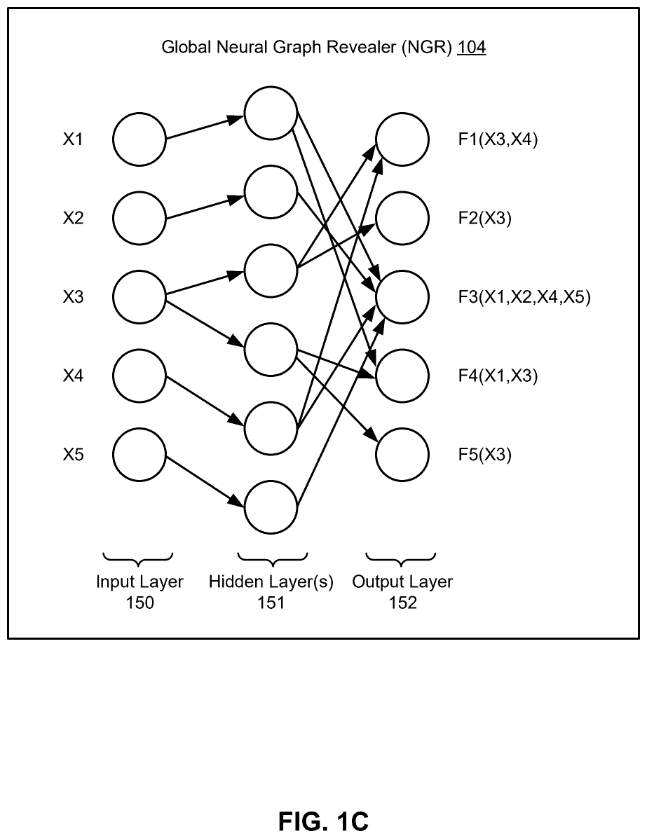

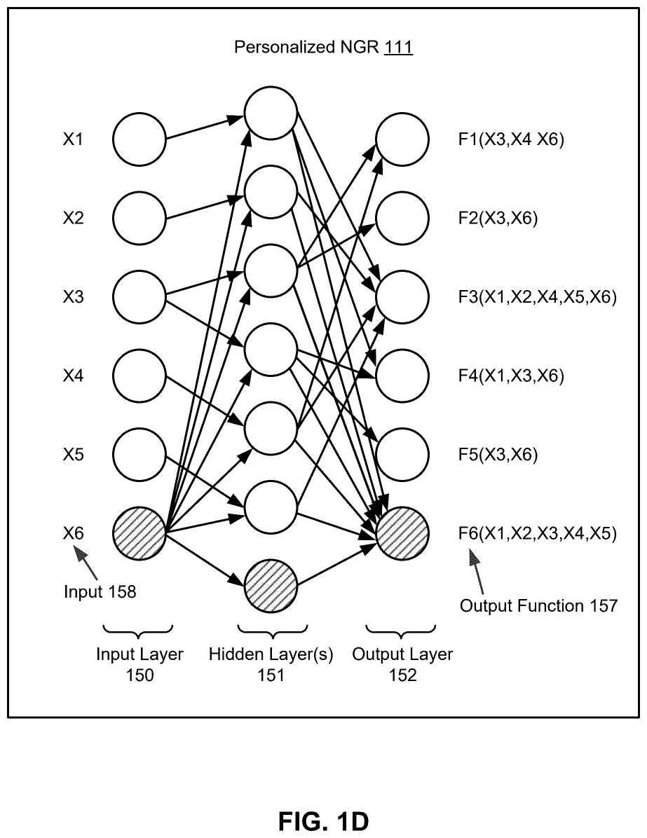

FIG. 1A depicts one embodiment of a networked computing environment 100 for providing a federated learning platform that utilizes NGRs. The networked computing environment 100 includes a master server 102 in communication with clients 112-113. Master server 102, client 112, and client 113 may comprise hardware computing devices or virtualized computing devices. The master server 102 includes a global NGR 104 (e.g., stored within a storage device or memory) and global NGR trainer 106 (e.g., for generating or training the global NGR 104). The client 112 includes model personalization 108 (e.g., for personalizing client NGR models for client 112 and performing stitching procedures for the local NGR 122). The client 113 includes model personalization 109 (e.g., for personalizing client NGR models for client 113 and performing stitching procedures for the local NGR 132).

The client 112 includes local data 121 that may include proprietary information or data that is private to the client 112, local NGR 122 (e.g., stored within a storage device), and local NGR trainer 123 (e.g., for generating or training the local NGR 122. The client 113 includes local data 131 that may include proprietary information or data that is private to the client 113, local NGR 132 (e.g., stored within a storage device), and local NGR trainer 133 (e.g., for generating or training the local NGR 132). The data of each client in communication with the master server 102 may have different distributions and/or different feature sets.

An NGR may comprise a type of probabilistic graphical model implemented using a deep neural network that handles complex distributions over a domain. A domain is a complex system that is being modeled (e.g., a disease process and the recorded ambient conditions might act as features). The NGR may represent complex distributions over the domain features without restrictions on the domain or predefined assumptions of the domain. In some cases, NGRs, such as the global NGR 104 and the local NGR 122, learn a feature dependency graph from data, while, at the same time, they learn to represent the probability function over the domain using a deep neural network with hidden layers. The parameterization of such a neural network can be learned from data efficiently, with a loss function that jointly optimizes dependency structure sparsity and fit to the data. Probability functions represented by NGRs are unrestricted by any of the common restrictions inherent in other PGMs.

In some cases, the master server 102 is a hardware server (e.g., a cloud server) that is remote from the clients 112-113 that are hardware computing devices and the master server 102 is accessed by the clients 112-113 via a network. The network may include the Internet or other data link that enables transport of electronic data between respective devices and components of the networked computing environment 100. In some cases, the clients 112-113 are devices in the cloud.

In some embodiments, a client, such as client 112, generates a local NGR, such as local NGR 122, using an NGR training application that trains the local NGR using local training data (e.g., data that is private to the client). In some cases, the local NGR represents a feature dependency graph. The feature dependency graph may be a part of the local NGR. In some cases, the local training data comprises multimodal data that spans different types of data (e.g., text, audio, and image data). In one example, each client has private datasets that include proprietary information that cannot be shared with other clients. The private datasets may cover the same domain {X1, X2, . . . , X_{C}}, where each dataset Xᵢ consists of Mᵢ samples, with each sample assigning values to the feature set Fᵢ for the client. The datasets may share some, but not all, features. Each dataset Xᵢ may contain only a subset of all features in the domain. Moreover, for some features, value sets overlap and for others they may be completely disjoint.

In some cases, each client trains a client-specific model based on their own data. A client may train or generate a model by utilizing backwards propagation of errors (or backpropagation) to train the model. In one example, each client generates a local NGR based on the local data of the client. The local NGRs, such as local NGR 122 and local NGR 132, for each client may be shared with the master server 102. The clients share their local NGRs without sharing their local data, that may include proprietary information; sharing the local NGRs with the master server 102 allows the local datasets to remain private for each client.

The master server 102 may then aggregate the local NGRs from each client and perform a merging operation to merge the local NGRs into a global NGR, such as global NGR 104. The global NGR 104 may incorporate common features across all client. The nodes of the global NGR 104 may contain an intersection of features from all clients. After the global NGR 104 has been generated and stored, the master server 102 may transmit the global NGR 104 to each client. In turn, each client may then utilize a copy of the global NGR 104 along with their local data to generate an updated local NGR.

In some embodiments, each of the components of the networked computing environment 100 is in communication with each other using any suitable communication technologies. In some implementations, the components of the networked computing environment 100 include hardware, software, or both. For example, the components of the networked computing environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the networked computing environment 100 include hardware, such as a special purpose processing device to perform a certain function or group of functions. In some implementations, the components of the networked computing environment 100 include a combination of computer-executable instructions and hardware.

Some embodiments described herein utilize a fully connected neural network (NN) to learn a regression, with the nodes in both the input and output of the NN (e.g., a neural graph revealer or “NGR”) representing the features present in provided input data, and determine direct connections between features of the input data while the network satisfies one or more sparsity constraints. This regression may be used to recover a feature graph indicating direct connections between the features of the input data.

FIG. 1B depicts one embodiment in which a fully connected neural network 164 (e.g., a multilayer perceptron) is applied to a set of input data to generate a feature graph 166, in which features and connections are represented via nodes and edges. In one embodiment, neural network 164 (e.g., a fully connected multilayer perceptron) is applied to a collection of input data to generate an optimized regression model (e.g., a neural graph revealer) that indicates dependencies between various features of the input data. The neural network 164 includes input layer 150, one or more hidden layers 151, and output layer 152. In some embodiments, a graph recovery system applies the neural network 164 to a collection of input data and fits a regression model to the input data to determine paths (e.g., via the edges) through the neural network 164 between the various features. The resulting regression model (or NGR) may be represented as output functions associated with the output layer 152 for each of the features. In particular, the output functions 153 associated with the output layer 152 may include formulas that are functions of one or more of the input features. For example, each output function 153 may be expressed as a function of a set of one or more input features associated with the input layer 150. In this way, a graph dependency structure is learned at the same time as the neural graph revealer, not in a separate step.

In connection with the feature graph 166, each feature (or node) is expressed as a function of immediate (one-hop) neighbor features. Thus, each path through the neural network 164 may be expressed as a formula between two directly connected features. In the recovered feature graph 166, this may be displayed as neighboring nodes that are connected via an edge.

With respect to local training, initially, each client trains its own NGR model based on its own data Xc restricted to the global variable list Fg. The architecture of an NGR model is an MLP that takes in input features and fits a regression to get the same features as the output.

FIG. 1C depicts one embodiment of neural graph revealer (NGR) 104. In some embodiments, the nodes in the NGR 104 include rectified linear unit functions (ReLUs) configured to jointly discover feature dependency graph constraints while fitting an optimized regression model on the set of input features with the input and output nodes of the NGR 104 corresponding to the features of the input data.

In some embodiments, learning the NGR 104 includes recovering an adjacency matrix indicating direct connections between input features represented as nodes in the input layer 150 and respective output features represented as nodes in the output layer 152 while satisfying one or more sparsity constraints. Each direct connection indicated in the adjacency matrix is associated with a subset of paths between a subset of input features from the set of input features and respective output features while satisfying the one or more sparsity constraints. Moreover, learning the NGR 104 includes learning a function for each feature from the set of output features by fitting a regression with both the input and output of the NGR 104 being the given set of features from the input data.

One task in optimizing the NGR 104 is to design a neural graph revealer objective function such that it can jointly discover the feature dependency graph constraints (e.g., the sparsity constraints restricting self-correlating features and reducing a number of paths through the neural network) while fitting the regression on the input data. In one or more embodiments, it is observed that the product of weights of the neural network (Snn) is expressed with the following equation:

$${S}_{nn} = {\prod }_{l = 1}^{L} \vert {W}_{l} \vert = \vert {W}_{1} \vert \times \vert {W}_{2} \vert \times … \times \vert {W}_{L} \vert$$

This equation provides path dependencies between input and output features. It is noted that if Sₙₙ(xᵢ, xₒ)=0, then the output (xo) does not depend on the input (xi). This property of the multilayer perceptron is used to model the constraints along with finding a set of parameters {W, [symbol] } that minimize the regression loss expressed as the Euclidian distance between X_{D} and f_{W,} [symbol] (X_{D}).

In this example, a first optimization objective may be expressed as follows:

$${arg min}_{𝒲 , ℬ} {\sum }_{k = 1}^{M} {‖ {X}_{𝒟}^{k} - {f}_{𝒲 , ℬ} ( {X}_{𝒟}^{k} ) ‖}^{2} , s . t . sym ( {S}_{nn} ) * {S}_{diag} = 0$$

where

$$sym ( {S}_{n n} ) = ( {‖ {S}_{n n} ‖}_{2} + {‖ {S}_{n n} ‖}_{2}^{T} ) / 2$$

converts the path norm obtained by the neural network weights product

$${S}_{n n} = {\prod }_{i - 1}^{L} \vert {W}_{l} \vert ,$$

into a symmetric adjacency matrix in which S_{diag}∈ [symbol] ^{D×D} represents a matrix of zeroes except the diagonal entries being set to ones.

In some cases, a first constraint (e.g., avoiding self-referencing dependencies) may be included as the second term in the optimization objective function expressed above. In addition to the first constraint, a graph recovery system may introduce a second constraint to introduce sparsity in the path norms.

In this example, the sparsity constraint (e.g., the second constraint) may include a normalization term ∥sym(Sₙₙ)∥₁, which introduces sparsity in the path norms. Thus, including the constraints as Lagrangian terms and constants (λ, γ) which act as a tradeoff between fitting the regression term and satisfying corresponding constraints to recover a valid graph dependency structure (e.g., the regression model). In one or more embodiments, the resulting optimization function (a second optimization function) may be expressed as follows:

$${arg min}_{𝒲 , ℬ} {\sum }_{k = 1}^{M} {‖ {X}_{𝒟}^{k} - {f}_{𝒲 , ℬ} ( {X}_{𝒟}^{k} ) ‖}^{2} + λ {‖ sym ( {S}_{n n} ) * {S}_{diag} ‖}_{1} + γ {‖ sym ( {S}_{n n} ) ‖}_{1}$$

in which a first parameter (the minimization summation term) is the regression parameter, the second parameter (λ∥sym(Sₙₙ)*S_{diag}∥₁) is a first sparsity constraint that prevents each feature from having a self-referencing path to itself, and the third parameter (γ∥sym(Sₙₙ)∥₁ is a second sparsity constraint the ensures a measure of sparsity within the resulting regression model.

In some cases, the master server 102 only receives the locally trained NGR models from its clients and it has no access to their private data. The master server 102 generates a number of samples from each of the client NGR models. The number of samples may be proportional to the original size of the datasets local NGR models were trained on, if available. The task of the global model is to learn an average of the distributions represented by the local models. The global NGR is trained on client samples in the same way as the client models.

FIG. 1D depicts one embodiment in which additional nodes have been added to a personalized NGR 111. As depicted, an additional highlighted node has been added to the input layer 150, the hidden layer(s) 151, and the output layer 152. For performing the personalized federated learning stitching procedure, each client receives the trained global model NGR from the master server 102. Input 158 and output function 157 may correspond to client-specific features. The node added to the hidden layer(s) 151 may be introduced to facilitate capturing of dependencies between the common features and the newly added features. Only the weights on the new edges introduced by the additional nodes are learned from the client's data. One can potentially increase the number of the hidden units for desired results.

In some cases, a stitching procedure may be utilized to incorporate client-specific features into a global NGR generated by the master server 102. Nodes (or units) for the client-specific features may be added to the input and output layers and additional hidden nodes may be added to each hidden layer. Then, all new input nodes are connected to the first hidden layer nodes and all nodes in the last hidden layer are connected to the new nodes in the output layer. Additionally, all input layer nodes are connected to the new nodes in the first hidden layer and all new nodes in the last hidden layer are connected to all output nodes. The connections between hidden layers may be added analogously. Then, the weights of the new local model are initialized and the local model is retrained using the client's data (e.g., by freezing the weights obtained by the global model, with sparsity constraint applied to new weights only).

In some embodiments, to further constrain potential data leakage from shared model weights, a precaution of not sharing either the updated global dependency graph or the global NGR master model with any clients may be instituted unless updates are based on data from at least a threshold number of clients (e.g., from at least ten clients).

In some embodiments, the master server detects that at least a threshold number of local NGR models have been received from a threshold number of clients and generates a global NGR model using the local NGR models in response to detection that at least the threshold number of local NGR models have been received from the threshold number of clients. In one example, the master server only generates the global NGR model if at least ten local NGR models are received from ten different clients.

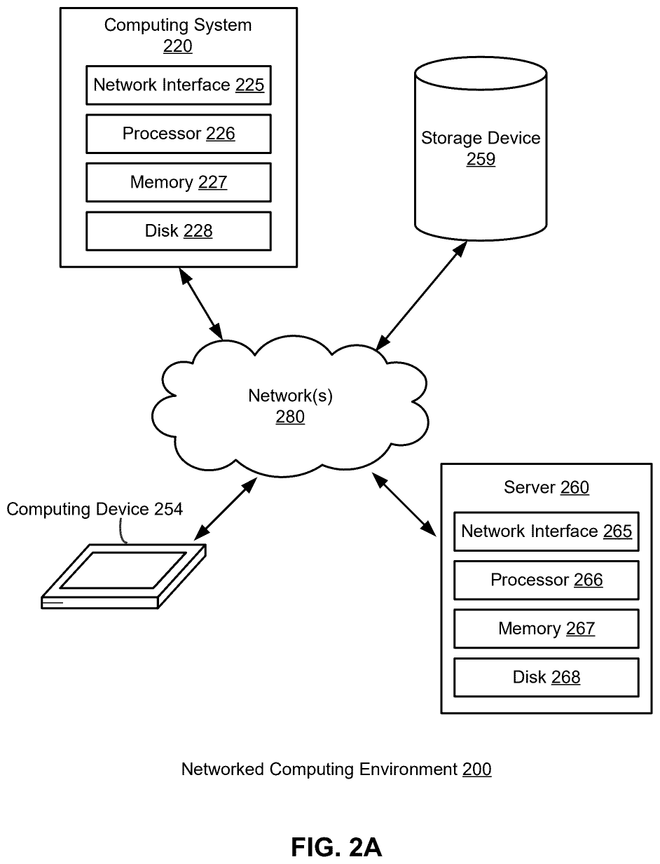

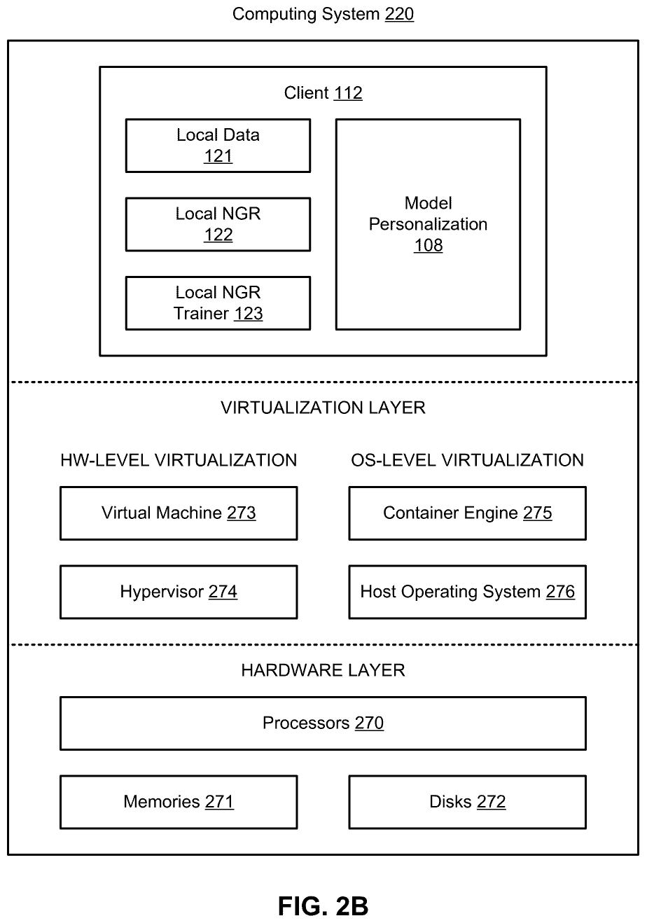

FIG. 2A depicts one embodiment of a networked computing environment 200 in which the disclosed technology may be practiced. The networked computing environment 200 includes a computing system 220, storage device 259, server 260, and a computing device 254 in communication with each other via one or more networks 280. The networked computing environment 200 may include various computing and storage devices interconnected through one or more networks 280. The networked computing environment 200 may correspond with or provide access to a cloud computing environment providing Software-as-a-Service (SaaS) or Infrastructure-as-a-Service (IaaS) services. The one or more networks 280 may allow computing devices and/or storage devices to connect to and communicate with other computing devices and/or other storage devices. In some cases, the networked computing environment 200 may include other computing devices and/or other storage devices not shown. The other computing devices may include, for example, a mobile computing device, a non-mobile computing device, a server, a workstation, a laptop computer, a tablet computer, a desktop computer, or an information processing system. The other storage devices may include, for example, a storage area network storage device, a networked-attached storage device, a hard disk drive, a solid-state drive, a data storage system, or a cloud-based data storage system. The one or more networks 280 may include a cellular network, a mobile network, a wireless network, a wired network, a secure network such as an enterprise private network, an unsecure network such as a wireless open network, a local area network (LAN), a wide area network (WAN), the Internet, or a combination of networks.

In some embodiments, the computing devices within the networked computing environment 200 comprises real hardware computing devices or virtual computing devices, such as one or more virtual machines. The storage devices within the networked computing environment 200 may comprise real hardware storage devices or virtual storage devices, such as one or more virtual disks. The real hardware storage devices may include non-volatile and volatile storage devices.

The computing system 220 may comprise a distributed computing system or a system for providing a cloud-based computing environment. As depicted in FIG. 2A, the computing system 220 includes a network interface 225, processor 226, memory 227, and disk 228 all in communication with each other. The network interface 225, processor 226, memory 227, and disk 228 may comprise real components or virtualized components. In some cases, the network interface 225, processor 226, memory 227, and disk 228 may be provided by a virtualized infrastructure or a cloud-based infrastructure. Network interface 225 allows the computing system 220 to connect to one or more networks 280. Network interface 225 may include a wireless network interface and/or a wired network interface. Processor 226 allows the computing system 220 to execute computer readable instructions stored in memory 227 in order to perform processes described herein. Processor 226 may include one or more processing units, such as one or more CPUs, one or more GPUs, and/or one or more NPUs. Memory 227 may comprise one or more types of memory (e.g., RAM, SRAM, DRAM, EEPROM, Flash). Disk 228 may include a hard disk drive and/or a solid-state drive. Memory 227 and disk 228 may comprise hardware storage devices.

The computing device 254 may comprise a mobile computing device, such as a tablet computer, that allows a user to access a graphical user interface for the computing system 220. A user interface may be provided by the computing system 220 and displayed using a display screen of the computing device 254.

A server, such as server 260, may allow a client device, such as the computing system 220 or computing device 254, to download information or files (e.g., executable, text, application, audio, image, or video files) from the server. The server 260 may comprise a hardware server. In some cases, the server may act as an application server or a file server. In general, a server may refer to a hardware device that acts as the host in a client-server relationship or to a software process that shares a resource with or performs work for one or more clients. The server 260 may store or provide access to a database.

The server 260 includes a network interface 265, processor 266, memory 267, and disk 268 all in communication with each other. Network interface 265 allows server 260 to connect to one or more networks 280. Network interface 265 may include a wireless network interface and/or a wired network interface. Processor 266 allows server 260 to execute computer readable instructions stored in memory 267 in order to perform processes described herein. Processor 266 may include one or more processing units, such as one or more CPUs, one or more GPUs, and/or one or more NPUs. Memory 267 may comprise one or more types of memory (e.g., RAM, SRAM, DRAM, EEPROM, Flash). Disk 268 may include a hard disk drive and/or a solid-state drive. In some cases, the disk 268 includes a flash-based SSD or a hybrid HDD/SSD drive. Memory 267 and disk 268 may comprise hardware storage devices.

The networked computing environment 200 may provide a cloud computing environment for one or more computing devices. In one embodiment, the networked computing environment 200 may include a virtualized infrastructure that provides software, data processing, and/or data storage services to end users accessing the services via the networked computing environment. In one example, networked computing environment 200 may provide cloud-based applications to computing devices, such as computing device 254, using the computing system 220, storage device 259, and/or server 260.

FIG. 2B depicts one embodiment of various components of the computing system 220 in FIG. 2A. As depicted, the computing system 220 includes hardware-level components and software-level components. The hardware-level components may include one or more processors 270, one or more memories 271, and one or more disks 272. The one or more processors 270 may include one or more processing units, such as one or more CPUs, one or more GPUs, and/or one or more NPUs. The one or more memories 271 may comprise one or more types of memory (e.g., RAM, SRAM, DRAM, EEPROM, Flash). The one or more disks 272 may include a hard disk drive and/or a solid-state drive. Both the one or more memories 271 and the one or more disks 272 may comprise hardware storage devices.

The software-level components may include software applications and computer programs. The client 112 including model personalization 108 may be stored or implemented using software or a combination of hardware and software. In some cases, the software-level components are run using a dedicated hardware server. In other cases, the software-level components may be run using a virtual machine or containerized environment running on a plurality of machines. In various embodiments, the software-level components may be run from the cloud (e.g., the software-level components may be deployed using a cloud-based compute and storage infrastructure).

As depicted in FIG. 2B, the software-level components may also include virtualization layer processes, such as virtual machine 273, hypervisor 274, container engine 275, and host operating system 276. The hypervisor 274 may comprise a native hypervisor (or bare-metal hypervisor) or a hosted hypervisor (or type 2 hypervisor). The hypervisor 274 may provide a virtual operating platform for running one or more virtual machines, such as virtual machine 273. A hypervisor may comprise software that creates and runs virtual machine instances. Virtual machine 273 may include a plurality of virtual hardware devices, such as a virtual processor, a virtual memory, and a virtual disk. The virtual machine 273 may include a guest operating system that has the capability to run one or more software applications. The virtual machine 273 may run the host operation system 276 upon which the container engine 275 may run.

The container engine 275 may run on top of the host operating system 276 in order to run multiple isolated instances (or containers) on the same operating system kernel of the host operating system 276. Containers may facilitate virtualization at the operating system level and may provide a virtualized environment for running applications and their dependencies. Containerized applications may comprise applications that run within an isolated runtime environment (or container). The container engine 275 may acquire a container image and convert the container image into running processes. In some cases, the container engine 275 may group containers that make up an application into logical units (or pods). A pod may contain one or more containers and all containers in a pod may run on the same node in a cluster. Each pod may serve as a deployment unit for the cluster. Each pod may run a single instance of an application.

In some embodiments, the depicted components of the computing system 220 including the model personalization 108 are implemented in the cloud or in a virtualized environment that allows virtual hardware to be created and decoupled from the underlying physical hardware.

The local NGR 122 may comprise one or more machine learning models. The one or more machine learning models may include one or more neural networks. A neural network may comprise a feed-forward neural network or a multi-layer perceptron, recurrent neural network, or a convolutional neural network. The one or more machine learning models may include one or more generative AI models. The one or more machine learning models may include one or more multimodal models. The one or more machine learning models may include one or more large language models.

Multimodal learning may refer to a type of machine learning in which a machine learning model is trained to understand multiple forms of input data (e.g., text, images, video, and audio data) that derive from different modalities. A multimodal model may comprise a model whose inputs and/or outputs include more than one modality. For example, a multimodal model may take both an image and a text caption as input features, and output a score indicating how appropriate the text caption is for the image. Image data may include different types of images, such as color images, depth images, X-ray images, magnetic resonance imaging (MRI) images, and thermal images. In some cases, a machine learning model comprises a multimodal model, a language model, or a visual model.

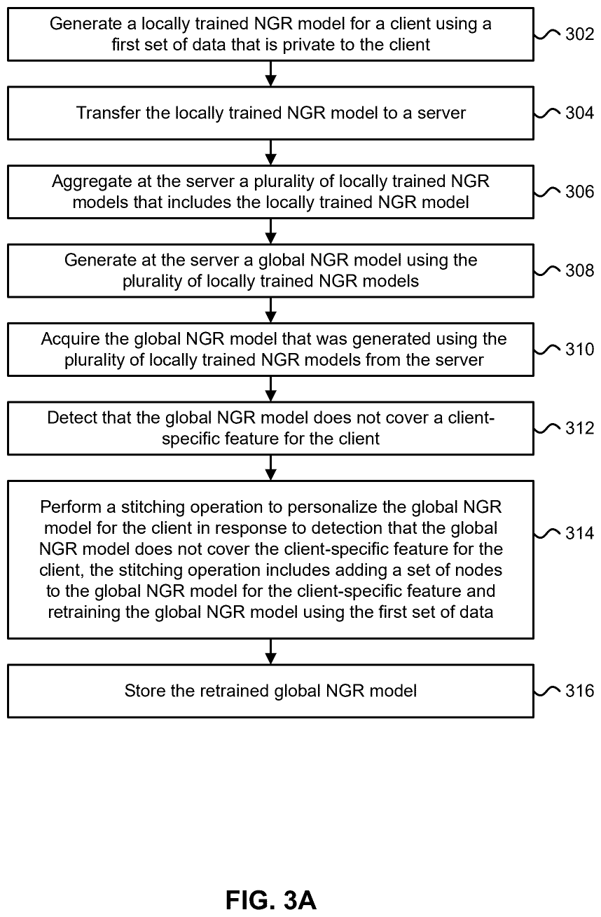

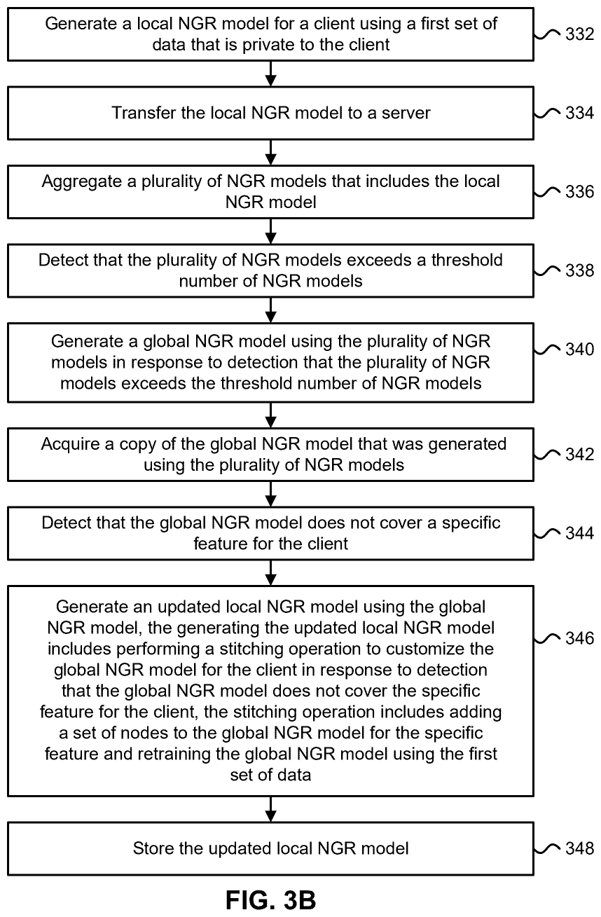

FIG. 3A depicts a flowchart describing one embodiment of a process for generating an NGR model, such as an updated client-specific NGR model. In one embodiment, the process of FIG. 3A may be performed by a computing system, such as the computing system 220 in FIG. 2B. In another embodiment, the process of FIG. 3A may be implemented using a cloud-based computing platform or cloud-based computing services.

In step 302, a locally trained NGR model for a client is generated using a first set of data that is private to the client. The client may correspond to client 112 in FIG. 1A. The locally trained NGR model may correspond to the local NGR 122 in FIG. 1A. In step 304, the locally trained NGR model is transferred to a server. The server may correspond to master server 102. In step 306, a plurality of locally trained NGR models that includes the locally trained NGR model is aggregated at the server.

In step 308, a global NGR model is generated at the server using the plurality of locally trained NGR models. In step 310, the global NGR model that was generated using the plurality of locally trained NGR models is acquired from the server by the client. In some cases, subsequent to generation of the global NGR model, a copy of the global NGR model is transferred from the server to the client.

In step 312, it is detected that the global NGR model does not cover a client-specific feature for the client. In step 314, a stitching operation is performed to personalize the global NGR model for the client in response to detection that the global NGR model does not cover the client-specific feature for the client. The stitching operation includes adding a set of nodes to the global NGR model for the client-specific feature and retraining the global NGR model using the first set of data. In step 316, the retrained global NGR model is stored.

FIG. 3B depicts a flowchart describing another embodiment of a process for generating an NGR model, such as an updated client-specific NGR model. In one embodiment, the process of FIG. 3B may be performed by a computing system, such as the computing system 220 in FIG. 2B. In another embodiment, the process of FIG. 3B may be implemented using a cloud-based computing platform or cloud-based computing services.

In step 332, a local NGR model for a client is generated using a first set of data that is private to the client. In step 334, the local NGR model is transferred to a server. In step 336, a plurality of NGR models that includes the local NGR model is aggregated. In step 338, it is detected that the plurality of NGR models exceeds a threshold number of NGR models. In step 340, a global NGR model is generated or trained using the plurality of NGR models in response to detection that the plurality of NGR models exceeds the threshold number of NGR models. In step 342, a copy of the global NGR model that was generated using the plurality of NGR models is acquired. In some cases, once the global NGR model is trained, a copy of the global NGR model is transferred from the server to the client.

In step 344, it is detected that the global NGR model does not cover a specific feature for the client. In step 346, an updated local NGR model is generated using the global NGR model. The generation of the updated local NGR model includes performing a stitching operation to customize the global NGR model for the client in response to detection that the global NGR model does not cover the specific feature for the client. In some cases, the stitching operation modifies a copy of the global NGR model to a client-specific local NGR model that is customized to cover the specific feature for the client. The stitching operation includes adding a set of nodes to the global NGR model for the specific feature and retraining the global NGR model using the first set of data. In some cases, the global NGR model replaces the local NGR model and then the set of nodes may be added to the local NGR model prior to retraining the local NGR model to generate the updated local NGR model.

In some cases, when the set of nodes is added to an NGR model, nodes may be added to the input and output layers of the NGR model and additional hidden nodes may be added to each hidden layer of the NGR model. Moreover, all new input nodes are connected to the first hidden layer nodes and all nodes in the last hidden layer are connected to the new nodes in the output layer. Additionally, all input layer nodes are connected to the new nodes in the first hidden layer and all new nodes in the last hidden layer are connected to all output nodes.

At least one embodiment of the disclosed technology includes a storage device for storing instructions that, when executed, cause a system to perform operations comprising generating a local NGR model for a client using a first set of data that is private to the client; transferring the local NGR model to a server; acquiring a global NGR model that was generated using a plurality of NGR models that includes the local NGR model; detecting that the global NGR model does not cover a specific feature for the client; generating an updated local NGR model using the global NGR model, the generating the updated local NGR model includes performing a stitching operation to customize the global NGR model for the client in response to detecting that the global NGR model does not cover the specific feature for the client, the stitching operation includes adding a set of nodes to the global NGR model for the specific feature and retraining the global NGR model using the first set of data; and storing the updated local NGR model.

At least one embodiment of the disclosed technology includes generating a local NGR model for a client using a first set of data; transferring the local NGR model to a server; acquiring a global NGR model that was generated using a plurality of NGR models that includes the local NGR model; detecting that the global NGR model does not cover a specific feature for the client; generating an updated local NGR model using the global NGR model, the generating the updated local NGR model includes performing a stitching operation in response to detecting that the global NGR model does not cover the specific feature for the client, the stitching operation includes adding a set of nodes to the global NGR model for the specific feature and retraining the global NGR model using the first set of data; and storing the updated local NGR model.

At least one embodiment of the disclosed technology includes one or more processors configured to generate a local NGR model for a client using a first set of data; acquire a global NGR model that was generated using a plurality of NGR models that includes the local NGR model; detect that the global NGR model does not cover a specific feature for the client; generate an updated local NGR model using the global NGR model, the generation of the updated local NGR model includes performance of a stitching operation in response to detection that the global NGR model does not cover the specific feature for the client, the stitching operation includes adding a set of nodes to the global NGR model for the specific feature and retraining the global NGR model using the first set of data; and store the updated local NGR model on the client.

The disclosed technology may be described in the context of computer-executable instructions being executed by a computer or processor. The computer-executable instructions may correspond with portions of computer program code, routines, programs, objects, software components, data structures, or other types of computer-related structures that may be used to perform processes using a computer. Computer program code used for implementing various operations or aspects of the disclosed technology may be developed using one or more programming languages, including an object oriented programming language such as Java or C++, a function programming language such as Lisp, a procedural programming language such as the “C” programming language or Visual Basic, or a dynamic programming language such as Python or JavaScript. In some cases, computer program code or machine-level instructions derived from the computer program code may execute entirely on an end user's computer, partly on an end user's computer, partly on an end user's computer and partly on a remote computer, or entirely on a remote computer or server.

The flowcharts and block diagrams in the figures provide illustrations of the architecture, functionality, and operation of possible implementations of systems, methods, and computer program products according to various aspects of the disclosed technology. In this regard, each step in a flowchart may correspond with a program module or portion of computer program code, which may comprise one or more computer-executable instructions for implementing the specified functionality. In some implementations, the functionality noted within a step may occur out of the order noted in the figures. For example, two steps shown in succession may, in fact, be executed substantially concurrently, or the steps may sometimes be executed in the reverse order, depending upon the functionality involved. In some implementations, steps may be omitted and other steps added without departing from the spirit and scope of the present subject matter. In some implementations, the functionality noted within a step may be implemented using hardware, software, or a combination of hardware and software. As examples, the hardware may include microcontrollers, microprocessors, field programmable gate arrays (FPGAs), and electronic circuitry.

For purposes of this document, the term “processor” may refer to a real hardware processor or a virtual processor, unless expressly stated otherwise. A virtual machine may include one or more virtual hardware devices, such as a virtual processor and a virtual memory in communication with the virtual processor.

For purposes of this document, it should be noted that the dimensions of the various features depicted in the figures may not necessarily be drawn to scale.

For purposes of this document, reference in the specification to “an embodiment,” “one embodiment,” “some embodiments,” “another embodiment,” and other variations thereof may be used to describe various features, functions, or structures that are included in at least one or more embodiments and do not necessarily refer to the same embodiment unless the context clearly dictates otherwise.

For purposes of this document, a connection may be a direct connection or an indirect connection (e.g., via another part). In some cases, when an element is referred to as being connected or coupled to another element, the element may be directly connected to the other element or indirectly connected to the other element via intervening elements. When an element is referred to as being directly connected to another element, then there are no intervening elements between the element and the other element.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify or distinguish separate objects.

For purposes of this document, the term “set” of objects may refer to a “set” of one or more of the objects.

For purposes of this document, the phrases “a first object corresponds with a second object” and “a first object corresponds to a second object” may refer to the first object and the second object being equivalent, analogous, or related in character or function.

For purposes of this document, the term “or” should be interpreted in the conjunctive and the disjunctive. A list of items linked with the conjunction “or” should not be read as requiring mutual exclusivity among the items, but rather should be read as “and/or” unless expressly stated otherwise. The terms “at least one,” “one or more,” and “and/or,” as used herein, are open-ended expressions that are both conjunctive and disjunctive in operation. The phrase “A and/or B” covers embodiments having element A alone, element B alone, or elements A and B taken together. The phrase “at least one of A, B, and C” covers embodiments having element A alone, element B alone, element C alone, elements A and B together, elements A and C together, elements B and C together, or elements A, B, and C together. The indefinite articles “a” and “an,” as used herein, should typically be interpreted to mean “at least one” or “one or more,” unless expressly stated otherwise.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for generating a client-specific neural graph revealer (NGR) model, comprising:
a storage device for storing instructions that, when executed, cause the system to perform operations comprising:
generating a local NGR model for a client using a first set of data that is private to the client;
transferring the local NGR model to a server;
acquiring a global NGR model that was generated using a plurality of NGR models that includes the local NGR model;
detecting that the global NGR model does not cover a specific feature for the client;
generating an updated local NGR model using the global NGR model, the generating the updated local NGR model includes performing a stitching operation to customize the global NGR model for the client in response to detecting that the global NGR model does not cover the specific feature for the client, the stitching operation includes adding a set of nodes to the global NGR model for the specific feature and retraining the global NGR model using the first set of data; and
storing the updated local NGR model.

2. The system of claim 1, further comprising instructions that, when executed, cause the system to perform operations comprising:
aggregating the plurality of NGR models that includes the local NGR model;
detecting that the plurality of NGR models exceeds a threshold number of NGR models; and
generating the global NGR model using the plurality of NGR models in response to detecting that the plurality of NGR models exceeds the threshold number of NGR models.

3. The system of claim 1, wherein:
the adding the set of nodes to the global NGR model includes adding nodes for the specific feature to input and output layers of the global NGR model prior to retraining the global NGR model using the first set of data.

4. The system of claim 1, wherein:
the adding the set of nodes to the global NGR model includes adding a new node to a hidden layer of the global NGR model prior to retraining the global NGR model using the first set of data.

5. The system of claim 3, wherein:
the generating the updated local NGR model includes connecting all new input nodes in the input layer to all nodes in a hidden layer and connecting all new nodes in the hidden layer to new nodes in the output layer.

6. The system of claim 1, wherein:
the generating the updated local NGR model includes freezing weights obtained by the global NGR model prior to retraining the global NGR model using the first set of data.

7. The system of claim 1, wherein:
the client comprises a first computing device; and
the server comprises a second computing device.

8. The system of claim 2, wherein:
the threshold number of NGR models comprises at least two NGR models from at least two different clients.

9. The system of claim 1, wherein:
the system resides on the client.

10. The system of claim 1, wherein:
the updated local NGR model comprises a type of probabilistic graphical model.

11. A method, comprising:
generating a local NGR model for a client using a first set of data;
transferring the local NGR model to a server;
acquiring a global NGR model that was generated using a plurality of NGR models that includes the local NGR model;
detecting that the global NGR model does not cover a specific feature for the client;
generating an updated local NGR model using the global NGR model, the generating the updated local NGR model includes performing a stitching operation in response to detecting that the global NGR model does not cover the specific feature for the client, the stitching operation includes adding a set of nodes to the global NGR model for the specific feature and retraining the global NGR model using the first set of data; and
storing the updated local NGR model.

12. The method of claim 11, further comprising:
aggregating the plurality of NGR models;
detecting that the plurality of NGR models exceeds a threshold number of NGR models; and
generating the global NGR model using the plurality of NGR models in response to detecting that the plurality of NGR models exceeds the threshold number of NGR models.

13. The method of claim 11, wherein:
the adding the set of nodes to the global NGR model includes adding nodes for the specific feature to input and output layers of the global NGR model prior to retraining the global NGR model using the first set of data.

14. The method of claim 11, wherein:
the adding the set of nodes to the global NGR model includes adding a new node to a hidden layer of the global NGR model prior to retraining the global NGR model using the first set of data.

15. The method of claim 11, wherein:
the generating the updated local NGR model includes freezing weights obtained from the global NGR model prior to retraining the global NGR model using the first set of data.

16. The method of claim 11, wherein:
the client comprises a first computing device; and
the server comprises a second computing device.

17. The method of claim 11, wherein:
the threshold number of NGR models comprises at least three NGR models.

18. The method of claim 11, wherein:
the generating the updated local NGR model using the global NGR model is performed by the client.

19. A system, comprising:
one or more processors configured to:
generate a local NGR model for a client using a first set of data;
acquire a global NGR model that was generated using a plurality of NGR models that includes the local NGR model;
detect that the global NGR model does not cover a specific feature for the client;
generate an updated local NGR model using the global NGR model, the generation of the updated local NGR model includes performance of a stitching operation in response to detection that the global NGR model does not cover the specific feature for the client, the stitching operation includes adding a set of nodes to the global NGR model for the specific feature and retraining the global NGR model using the first set of data; and
store the updated local NGR model on the client.

20. The system of claim 19, wherein:
the set of nodes is added to input and output layers of the global NGR model prior to retraining the global NGR model using the first set of data.
